(19) United States
(12) Patent Application Publication
(10) Pub. No.: US 2010/0158618 A1
(43) Pub. Date: Jun. 24, 2010

(54) METHOD OF MODIFYING THE AXIS OF ROTATION OF THE EARTH

(76) Inventor: William T. Carpenter, Vail, CO (US)

Correspondence Address: FULBRIGHT & JAWORSKI, LLP, 1301 MCKINNEY, SUITE 5100, HOUSTON, TX, 77010-3095, US

(21) Appl. No.: 12/717,495

(22) Filed: Mar. 4, 2010

Related U.S. Application Data
(63) Continuation of application No. 09/773,815, filed on Jan. 31, 2001, now abandoned.
Application No. 09/773,815 is a continuation of application No. 09/382,052, filed on Aug. 24, 1999, now abandoned.
Application No. 09/382,052 is a continuation-in-part of application No. 08/920,343, filed on Aug. 27, 1997, now abandoned.

(51) Int. Cl. E99Z 99/00

(52) U.S. Cl. 405/303

(57) ABSTRACT

A method of modifying the Earth-rotation vector relative to the body of the planet or in inertial space by redistribution of the Earth's mass.

This application is a continuation of U.S. application Ser. No. 09/773,815 filed Jan. 31, 2001 which is a continuation of U.S. Ser. No. 09/382,052 filed Aug. 24, 1999, now abandoned, which is a continuation-in-part of U.S. Ser. No. 08/920,343 filed on Aug. 27, 1997, now abandoned.

### BACKGROUND OF THE INVENTION

1. Technical Field

This invention relates to the method and apparatus for altering the center of mass of the Earth and more particularly to the redistribution of mass in the crust.

2. Description of Prior Art

It is recognized that the variability of the earth-rotation vector relative to the body of the planet, or in inertial space, is caused by the combination of the gravitational torque exerted by the Moon, Sun, and planets, displacement of matter in different parts of the planet and other excitation mechanisms. The observed oscillations can be interpreted in terms of mantle elasticity, earth flattening, structure and properties of the core-mantle boundary, the coupling between the other various layers of our planet, rheology of the core, underground water, oceanic variability, and atmospheric variability on time scales of weather or climate. Continuing research into the interrelationship and reactions of these factors will provide means to further quantify these processes.

Geodesy is a relatively new field of study which encompasses the above interrelated factors and when combined with several satellite-geodesy techniques has contributed to the permanent monitoring of the Earth's rotation. The measurements of the Earth's rotation are under the form of time series of the so-called earth orientation parameters (EOP) and when combined with the measurements of Universal time (UTI), polar motion and the celestial motion of the pole (precession/nutation) give access to the time variations of the Earth's gravity field. These time variations reflect the evolution of the Earth's shape, the redistribution of masses in the planet including those redistribution's of mass in the atmosphere, oceans, and the solid Earth.

The International Earth Rotation Service was created in 1988 to maintain the International Celestial Reference System and Frame, the International Terrestrial Reference System and Frame, and to provide timely and accurate data on the Earth's orientation for current use and long term studies. This service is interdisciplinary and maintains key connections between astronomy, geodesy, and geophysics which interaction provides basic results that are useful in all these disciplines and past data, going back to the 17th century in some cases, are also available. Universal time and polar motion are available daily and celestial pole motion is available every five to seven days.

This variability of the earth-rotation vector has been described as the action observed in a top spinning down whereby the motion of the axis of rotation describes a figure eight at the poles of the earth. This “wobble” is known as the Chandler Effect and has been chronicled in numerous publications.

We know that the geological age of the oldest Precambrian rocks is 3800 million years and the oldest fossils are 3000 million years old. Next, during the Paleozoic period, which lasted 325 million years life grew from multi-cells to the dinosaurs on the giant continent of Pangaea. During the next Mesozoic period, which lasted a total 179 million years Pangaea broke apart and the dinosaurs became extinct in what was believed to be a sudden epochal change. During the next Tertiary era which lasted 64 million years we had a very hot planet Earth with palm trees at the north pole. The Pleistocene period then lasted 2 million years and the Holocene has been in evidence for the last 10,000 years and has brought the first appearance of Homo Sapiens and 4 ice ages.

Of course there is no data for the axis of rotation of our planet Earth during the Precambrian nor the millions of years that followed but we do have the data today and some of it goes back to the 17th century. The axis has changed slowly until the last 100 years when the rate of change increased so that during this relatively short period approximately 70% of the total deviation from the mean has occurred. In the course of known Geologic time of 3800 million years this change of 70% in the variation of the Earth's axis of rotation during the last 100 years is truly spectacular, (sic) awesome.

During these last 100 years there has been no appreciable change in the rate of continental drift, plate tectonics, glaciers, atmospheric phenomena, or tidal cycles, however there have been changes in the Earth's core due to volcanic action and the gravitational torque of the Sun, Moon and planets. Moreover, during this last 100 years time frame some 100 trillion tons of mass have been redistributed on the planet Earth.

When hydrocarbons, either solid or liquid, are removed from a particular location in the Earth's crust and burned, the products of combustion are heat, water vapor and ash, all of which are eventually uniformly redistributed throughout the atmosphere. Therefore, those masses are effectively removed from their original locations on the rotating planet causing an imbalance and change in the center of mass of the Earth, thereby effecting the axis of rotation of the Earth.

Eventually some of the water extracted from reservoirs in the Earth's crust and used for irrigation or other forms of consumption makes its way through the Earth's regional drainage systems back to the ocean where it to it also redistributed uniformly throughout the planet and thereby its removal from its original locations similarly effects the location of the center of mass of the Earth.

Additionally, the trapping of surface water by damming natural drainage ways, and building of reservoirs for surface water and conversely the evaporation and drying of natural seas such as the Ural Sea have all contributed, some positively and some negatively, to changes in the balance of the planet brought about by mankind during these last 100 years.

Changes in the earth-rotation vector relative to the body of the planet or in inertial space changes the angle of incidence of the Sun's rays to the planet Earth. This has two effects on the amount of heart that is transmitted to the Earth. The first is convection differences and the second is filtration and diffusion by the Earth's atmosphere. The Earth is the hottest in the equatorial regions which are the closest to the Sun and the angle of incidence for the Sun's rays is the greatest making their path through the atmosphere the shortest thereby causing the least filtration and diffusion of the Sun's rays. On the other hand the coldest regions are at the poles which are the farthest from the Sun and the angle of incidence is the least making the path through the atmosphere the longest thereby causing the greatest filtration and diffusion of the Sun's rays.

### SUMMARY OF THE INVENTION

This invention is a method of modifying the earth-rotation vector in relation to the body of the planet or in inertial space by redistributing the mass in/or/on the crust of the earth. Such redistribution will change the center of mass of the Earth thereby causing a change in the earth-rotation vector.

### DETAILED DESCRIPTION OF THE INVENTION

The invention may be readily understood by those of ordinary skill in the art without the benefit of a drawing. It will be explained by illustrative reference to the Earth.

This invention is a method of modifying the axis of rotation of the earth. Since the earth is a rotating body with a known mass, size, shape, center of mass and axis characteristics the first step is to determine an optimum point to add or reduce mass to cause the desired change to the axis of rotation. The next step would be to alter the mass at that point or any series of points that would produce the desired effect. The amount of mass altered would be dependent upon the desired change to the Earth's center of mass and consequent changes to the axis of rotation. The desire is subjective to the user of the method and depends on the result sought. Such result can be reasonably determined by one of ordinary skill in the art.

In the best embodiment of the invention, water from the worlds oceans is contained in cavities or reservoirs either above ground or underground or both. Since the rotating Earth has a gravitational field that overpowers the centrifugal forces, at the crust's radius, that are caused by the rotation of our planet, it is unique from the sphere rotating on Earth. This gravitational field can hold a fluid mass in place on the surface of the Earth. This fluid mass, so held in place, tends to distribute and redistribute itself relatively equally over the surface of the oceans in which it is laterally contained, in conformity with the combined effects of the extraneous gravitational variations caused by the Sun, Moon, and other planets. Therefore this fluid mass of the oceans is the most ideal material to use for the redistribution mass because a portion of this fluid mass can be placed at some predetermined location, which would cause an actual redistribution of mass of the entire planet, because the remainder of this fluid mass of the oceans would then equally redistribute itself throughout the above referenced surface.

Capturing and removing of any portion of the fluid mass of the oceans would cause the remaining mass to be proportionately diminished. However, this diminishment would be equally diminished over the entire surface of the interconnected oceans of the planet and only the fluid, or sea, level would be effected. Therefore actual redistribution of mass of a planet can occur by moving a portion of this fluid mass from the area where it can redistribute itself and containing this removed portion in a manner where it cannot redistribute itself. Selectively containing any portion of this removed fluid mass in a predetermined, or any, location would thereby change the center of mass of the Earth and, since it is rotating in inertial space, thereby cause the axis of rotation to be altered. Such change in the axis of rotation changes the relationship to the Sun, Moon and other planets and would effect the Earth's climatic pattern due to the change in angle of incidence to the Sun.

There can be many combinations of materials and locations suitable for the purpose of this invention, which combination selection might be made with regard to available resources and expense. This material, substance or substances may be any material of adequate density, including water or soil. For example, salt water may be injected into underground cavities or reservoirs of the Earth, such as where hydrocarbons have been removed. The above referenced substance or substances may be placed in a cavity, though not necessarily. “Cavity” is intended to be any cavity or reservoir. The character of rotation of the planet Earth may be modified by the redistribution of mass, including placing or removing mass from desired areas to give a desired change in the character of the earth-rotation vector in relation to the body of the planet or in inertial space.

What is claimed is:

1. A method of modifying the orientation of the axis of rotation of a planet comprising the steps of:
measuring the mass of a planet;
determining the center of mass of the planet;
characterizing the orientation of the axis of rotation of the planet;
selecting a desired orientation of the axis of rotation;
calculating a moment of stability required to cause the desired orientation of the axis of rotation;
determining a position and a mass of compensating substance sufficient to effect the moment of stability; and
positioning the mass in the position.

2. The method of claim 1 in which the position of the compensating substance is positioned in an underground cavity.

3. The method of claim 1 in which the position of the compensating is positioned in an above ground cavity.

4. The method of claim 1 in which the substance is solid.

5. The method of claim 1 in which the substance is a liquid.

6. The method of claim 2 in which the substance is a liquid.

7. The method of claim 3 in which the substance is liquid.

8. The method of claim 5 in which the liquid is water.

9. The method of claim 6 in which the liquid is water.

10. The method of claim 7 in which the liquid is water.
